(19) United States
(12) Patent Application Publication
(10) Pub. No.: US 2026/0316934 A1
(43) Pub. Date: Oct. 15, 2026

(54) GALLEY INSTALLATION APPARATUS, AIRCRAFT INTERIOR EQUIPMENT MODULE AND AIRCRAFT

(71) Applicant: Airbus Operations GmbH, Hamburg (DE)

(72) Inventors: Sonja Kreplin, Hamburg (DE); Juergen Friedrich Haastert, Hamburg (DE)

(73) Assignee: Airbus Operations GmbH, Hamburg (DE)

(21) Appl. No.: 19/639,518

(22) Filed: Apr. 6, 2026

(30) Foreign Application Priority Data
Apr. 9, 2025 (DE) 102025114024.3

(51) Int. Cl. B64D 11/04; B64D 11/00

(52) U.S. Cl. CPC B64D 11/04; B64D 2011/0046

(57) ABSTRACT

A galley installation apparatus for aircraft includes a container with supply ports and at least one camera port, and an electrical direct view system in the container. A display device of the electrical direct view system is mounted pivotably on the container by at least one joint device whereby the display device is pivotable reversibly from at least one external position outside the container into an interior receiving region of the container. The container includes at least one fastening system for fastening to an aircraft interior equipment module such that a substantially fixed position of the electrical direct view system in the respective pivoted positions is able to be ensured during at least one use scenario. Also disclosed are an aircraft interior equipment module and an aircraft.

### TECHNICAL FIELD

The disclosure herein relates to a galley installation apparatus, to an aircraft interior equipment module and to an aircraft.

### BACKGROUND

The best possible use is intended to be made of the interior of aircraft on account of economic considerations. It is not just a matter of accommodating all the necessary equipment or generally all the technical modules in a space-saving manner, but also of conveying as many passengers as possible at the same time for economic and ecological reasons.

The cabin crew has, in particular, safety-related responsibilities within the aircraft interior.

These safety-related responsibilities include having visual contact of at least 80% of the passenger seats and 100% of the aisle during take-off and landing. While direct visual contact between cabin crew and passengers can frequently be enabled permanently during short-haul flights, since 2004 such duties have also been covered, in particular on medium-haul and long-haul flights, by electrical direct view systems (“eDirect View”).

Electrical direct view systems can already be equipped with appropriate camera modules or the like. Basic variants can also be designed without camera modules, however, these then being designed with camera modules that are already present in the aircraft interior or the like, such that the space to be monitored is visible on associated display devices in the form of monitors or the like.

The keeping of ever increasing numbers of technical appliances within the aircraft cabin is increasingly challenging since the available space in the aircraft is limited or is reserved for other purposes in each case, for example the space requirement for the passengers.

The prior art already discloses display devices of respective assistance systems, which are displaceably movable from an external position to an internal position in storage modules such that they accordingly need a certain space requirement in the external position only while they are actually in use. However, such systems are not designed for all use scenarios, since, for example, during relatively large sequences of movements of the aircraft, undesired vibrations can set the monitors in motion such that reliable and fault-free use is sometimes made much more difficult. In particular with regard to safety-related responsibilities, it is necessary to ensure as far as possible a clear and unimpeded view of the areas to be monitored within the aircraft at all times, wherein blurred images caused by vibrating display devices cannot suitably meet these requirements.

### SUMMARY

Against this background, the aim of the disclosure herein is to provide a galley installation apparatus, an aircraft interior equipment module and an aircraft which at least partially overcome the abovementioned drawbacks.

This object is achieved by a galley installation apparatus and an aircraft interior equipment module for aircraft, and also by an aircraft disclosed herein. Such a galley installation apparatus is a so-called Galley Insert, referred to as GAIN by those skilled in the art.

In principle, such an “aircraft interior equipment module” (also referred to as “monument” by those skilled in the art) may comprise in particular a galley and/or a lavatory and/or storage.

Provided according to the disclosure herein is a galley installation apparatus for aircraft, comprising a container with supply ports and at least one camera port, and an electrical direct view system arranged in the container, wherein a display device of the electrical direct view system is mounted pivotably on the container by at least one joint device such that the display device is pivotable reversibly from at least one external position outside the container into an interior receiving region of the container, wherein the container comprises at least one fastening system for fastening to an aircraft interior equipment module such that a substantially fixed position of the electrical direct view system in the respective pivoted positions is able to be ensured during at least one use scenario.

The supply ports may be, for example, ports according to ARINC 810 or comprise only these.

Furthermore, according to the disclosure herein, an aircraft interior equipment module for aircraft is provided, comprising at least one galley installation apparatus according to the disclosure herein.

Also provided according to the disclosure herein is an aircraft which comprises at least one galley installation apparatus according to the disclosure herein or an aircraft interior equipment module according to the disclosure herein.

Therefore, it is an idea of the disclosure herein to provide a galley installation apparatus in which an electrical direct view system with a display device is provided, wherein the display device is mounted movably in order both to be storable inside the galley installation apparatus and to be fully usable outside the latter for respective use intervals.

In this case, at least one fastening system for fastening to an aircraft interior equipment module is provided, in order thus to establish a particular basic stability such that a substantially fixed position of the electrical direct view system in the respective pivoted positions is able to be ensured during at least one use scenario. On account of the particular basic stability that is established, possible vibrations of the display device are reduced, and so the display device does not move excessively even in respective set external positions outside the container.

In particular, in extreme cases, vibration can thus be prevented.

This may be advantageous in particular in the case of heavy display devices, for example weighing up to 2 kilograms or the like.

Possible use scenarios can be considered to be, for instance, take-off or landing operations with accordingly particular movement influences in the aircraft interior. Use scenarios can also be considered to be any movement influences on the interior of the aircraft, which may arise during undesired turbulence during a flight.

A substantially fixed position means, in conjunction with the presented disclosure, that minimal movements take place only in a range, these not being readily directly discernible as such by the human eye. In other words, for instance on account of the substantially fixed position, undisturbed observation of media content shown on the display device is possible without limitation.

The abovementioned advantages also apply, where transferable, to the presented aircraft interior equipment module according to the disclosure herein for aircraft and to the presented aircraft according to the disclosure herein.

According to a further embodiment of the disclosure herein, provision is made for the display device to comprise a rear panel element by which the display device is coupled to the at least one joint device, wherein the rear panel element has reinforcements in the direction of the at least one joint device such that a center of gravity of the display device with the rear panel element is shifted in the direction of the at least one joint device.

A center of gravity shifted towards the at least one joint device surprisingly affords additional stability when the display device is in an external position, and so the desire for unimpeded inspection of displayed camera images can be satisfied even better. Thus, besides the stabilizing effects, already permanently existing, of the employed fastening systems (or only the one fastening system), additional stabilizing elements can be introduced such that advantageously even relatively heavy display devices, for example weighing up to 2 kilograms or even more, can be used stably in a variety of different use scenarios and can thus be used by a user, for instance the cabin crew, without disruption.

According to a further embodiment of the disclosure herein, provision is made for the display device to be horizontally movable in a continuously variable manner on the rear panel element, such that, depending on the use scenario that is set up, a center of gravity of the display device with the rear panel element is able to be shifted in the direction of the at least one joint device.

In this way, additional stability can be achieved in a surprisingly simple manner in order to achieve the abovementioned advantages. In particular when the pre-existing measures turn out to be not yet entirely sufficient, it is thus possible, by a simple and easily controllable adjustment operation, to achieve an advantageous improvement.

According to a further embodiment of the disclosure herein, provision is made for the at least one joint device to have reinforcements that at least partially overlap the rear panel element, such that a center of gravity of the display device with the rear panel element lies in the direction of the at least one joint device.

The at least one joint device can thus additionally enhance the abovementioned effects, such that, as a whole, even more stable positioning of the display device outside the container can be effected.

According to a further embodiment of the disclosure herein, provision is made for the supply ports and the at least one camera port in the container to be provided on the rear side on the opposite side from an opening region of the interior receiving region, such that the galley installation apparatus is able to be coupled automatically to supply media and cameras during a positioning process in an aircraft interior equipment module.

A particularly user-friendly apparatus can thus be provided in an advantageous manner.

According to a further embodiment of the disclosure herein, provision is made for at least one joint device to comprise at least one fixing mechanism such that the display device is able to be reversibly fixed in a substantially fixed position in the external position.

In this way, an additional mechanism or comparable additional technical solution is not required. Rather, it is thus possible to provide a reliable fixing function in a space-saving manner, wherein the operation at the joint device makes possible a device that is easy and intuitive to operate.

According to a further embodiment of the disclosure herein, provision is made for the at least one fastening system to comprise at least one rail system with at least one lock, by which the galley installation apparatus is movable on the aircraft interior equipment module so as to be reversibly extendable and retractable with a lock released and is provided in a substantially fixed position with a lock fixed.

The use of rail systems for fastening or for connecting between the two mentioned components affords the significant advantage that a connection is possible not only selectively at one location, but rather a direct connection can be realized along a relatively long section such that particularly stable fastening or connecting can be realized.

According to a further embodiment of the system according to the disclosure herein, provision is made for the aircraft interior equipment module according to the disclosure herein to be designed to receive the galley installation apparatus reversibly such that a display device is able to be oriented in the direction of at least one cabin crew seating area. This ensures that a cabin attendant seat (CAS) is arranged directly opposite the swung-out display arrangement. As a result, a member of crew sitting on a CAS during take-off and landing has a good view of the passenger seats to be monitored.

Thus, any requirements during the use of electrical direct view systems can be complied with in a surprisingly simple manner and additional particularly user-friendly use can be allowed.

### BRIEF DESCRIPTION OF THE DRAWINGS

The disclosure herein will be explained in more detail in the following text on the basis of the example embodiments illustrated in the schematic figures:

FIG. 1 shows a schematic perspective view of a galley installation apparatus for aircraft;

FIG. 2 shows a schematic cross-sectional view through an aircraft;

FIG. 3 shows a schematic plan view of an interior of an aircraft; and

FIG. 4 shows a schematic view of an aircraft according to the disclosure herein.

In the figures of the drawing, identical and functionally identical elements, features and components, and those having an identical effect, are each provided with the same reference sign unless stated otherwise.

### DETAILED DESCRIPTION

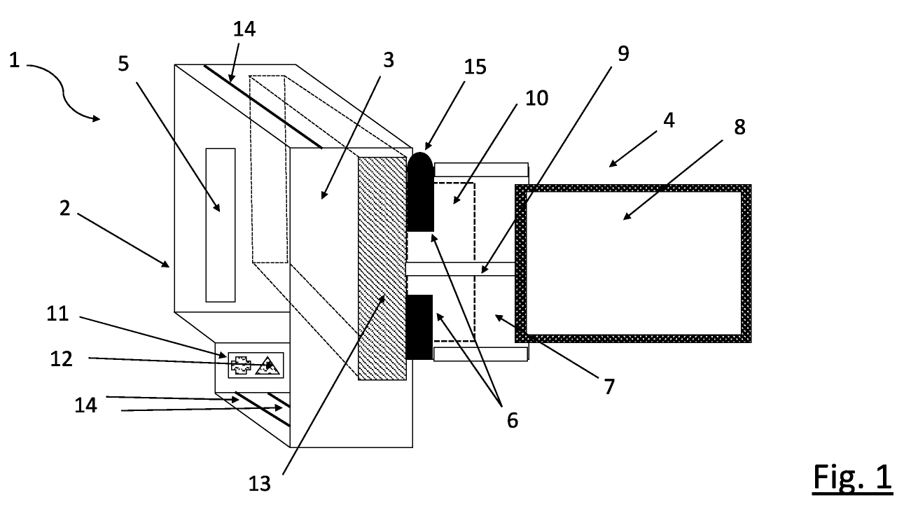

FIG. 1 shows a schematic perspective view of a galley installation apparatus 1 for aircraft. This galley installation apparatus 1 is illustrated in this case with a container 2, which has an interior receiving region 3.

A display device 4 is able to be placed in this interior receiving region 3 of the container 2. The display device 4 is illustrated in an external position outside the container 2 and, after its shown position is pivoted through about 90° to the left (with respect to the plane of the image), can be stored in the interior receiving region 3 of the container 2 by auxiliary structure(s) that are not illustrated in more detail. These auxiliary structure(s) may be, for example, rail elements on which the display device 4 can then be inserted into the interior receiving region 3 of the container 2.

The display device 4 is also a constituent part of an electrical direct view system 5 that is illustrated only a highly simplified manner. This electrical direct view system 5 may comprise any basic components, for instance control modules and connecting lines, etc., which are not illustrated in more detail, so that the functions associated therewith can be kept able to be carried out. In particular, this electrical direct view system 5 is designed to be able to be coupled to any camera systems in the aircraft interior, which systems may be arranged in different positions in the interior of an aircraft in which the galley installation apparatus 1 is installed.

The display device 4 is pivotable by two illustrated joint devices 6, wherein the joint devices 6 are arranged directly on a rear panel element 7 of the display device 4. A monitor unit 8 of the display device 4 is additionally illustrated arranged on this rear panel element 7 of the display device 4 so as to be horizontally movable (with respect to the plane of the image).

To this end, the monitor unit 8 is provided so as to be movable on a rail bar 9, wherein the forces to be employed for a movement are large enough that a position that has been set once is not possible on account of gentle shaking or the like. Alternatively, fixing elements, which are not illustrated in more detail, can be provided on the rail bar 9, these not being illustrated in more detail in this embodiment.

In a surface region 10 (illustrated by dashed lines), the rear panel element 7 of the display device 4 is provided with reinforcements, which are not illustrated in more detail. These reinforcements may be, for example, material reinforcements or particular material inlays made of heavy materials, for instance metal alloys or the like. Additionally arranged reinforcements in the form of additional separate components are also conceivable. These additional components may also be made of or comprise, for instance, metal alloys.

The container 2 is additionally illustrated with supply ports 11 and at least one camera port 12. They are illustrated only pars pro toto by respective symbols and are located analogously in the container 2 on the rear side on the opposite side from an opening region 13 of the interior receiving region 3, such that the galley installation apparatus 1 is able to be coupled automatically to supply media and cameras during a positioning process in an aircraft interior equipment module, which is not illustrated in more detail.

In this regard, the display device 2 of the electrical direct view system 5 is mounted pivotably on the container 2 by the two joint devices 6 such that the display device 2 is pivotable reversibly from at least one external position outside the container 2 into the interior receiving region 3 of the container 2, wherein the container 2 is also illustrated with a total of three fastening systems 14 for fastening to an aircraft interior equipment module which is not illustrated in more detail, such that a substantially fixed position of the electrical direct view system 5 is able to be ensured during at least one use scenario. The total of three illustrated fastening systems 14 can each be provided, for instance, as a rail system with at least one lock, such that the apparatus 1 may be retractable, by these fastening systems 14, into a slide-in compartment, provided therefor, of a module 17, which is not illustrated in more detail, and then be lockable in place therein.

The upper joint device 6 (with respect to the plane of the image) is illustrated with a fixing mechanism 15 such that the display device 4 is able to be reversibly fixed in a substantially fixed position in the external position. In this way, an additional mechanism or comparable additional technical solution is not required. Rather, it is thus possible to provide a reliable fixing function in a space-saving manner, wherein the operation at the joint device makes possible a device that is easy and intuitive to operate. This fixing mechanism 15 may comprise, for example, in a simple variant and illustrated analogously in FIG. 1, a button element which is coupled by a spring mechanism inside the upper joint device 6 such that fixing and releasing operations are able to be effected, similarly to the principle of a ball-point pen or the like.

Alternatively, the provided joint devices 6 can be designed such that a respective set pivoted position can be changed only if the cabin crew apply a certain amount of force, and shaking or vibrations or the like that arise cannot change this position.

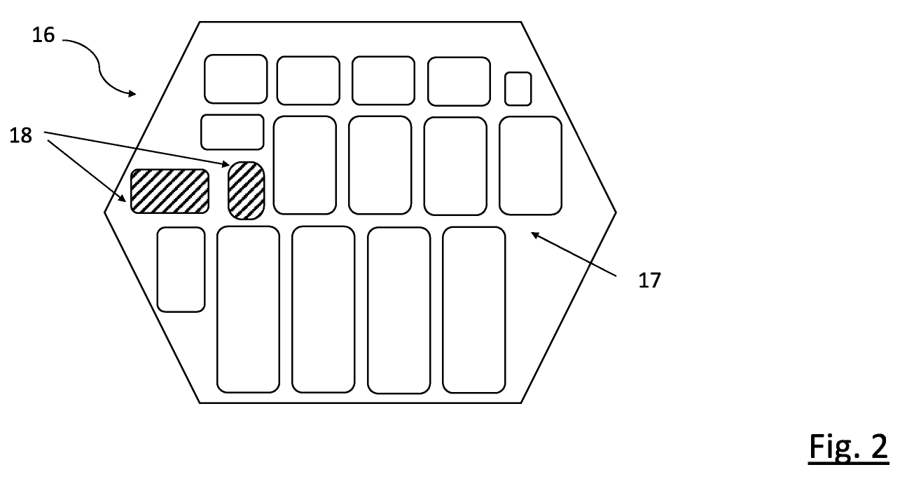

FIG. 2 shows a schematic cross-sectional view 16 through an aircraft. This cross-sectional view illustrates in particular the view of a one-part aircraft interior equipment module 17, specifically a schematically illustrated galley. In principle, an “equipment module” or, as mentioned above, a so-called monument can thus also comprise, for example, a galley on the left-hand side and one or more lavatories on the right, or vice versa, and/or also so-called storage monuments. Provided on the left (with regard to the plane of the image) in this aircraft interior equipment module 17 are two installation possibilities, i.e. placeholders 18, for a galley installation apparatus 1 according to the disclosure herein for aircraft.

In other words, it is conceivable for the shown aircraft interior equipment module 17 to be a galley of an aircraft, wherein the galley installation apparatus 1 according to the disclosure herein is able to be placed in this aircraft interior equipment module 17 and can be arranged there by at least one fastening system of the galley installation apparatus 1, such that a substantially fixed position of an electrical direct view system 5 of the galley installation apparatus 1 is able to be ensured during at least one use scenario.

In an embodiment variant that is not illustrated in more detail, it is conceivable for the placeholder 18 to be provided in some other position of the aircraft interior equipment module 17. Preferably, the galley installation apparatus 1 according to the disclosure herein is located on the outer left-hand or outer right-hand side of the monument (the specifications “left” and “right” relate here to the illustration in FIG. 2, but can also be understood in relation to a direction of view from an aisle located between passenger seats, preferably with the direction of view being counter to the flight direction).

In this way, the flight attendant seats can be arranged both on one side and on the other side opposite the monument, resulting in greater flexibility in the design of the aircraft interior (the “layout”).

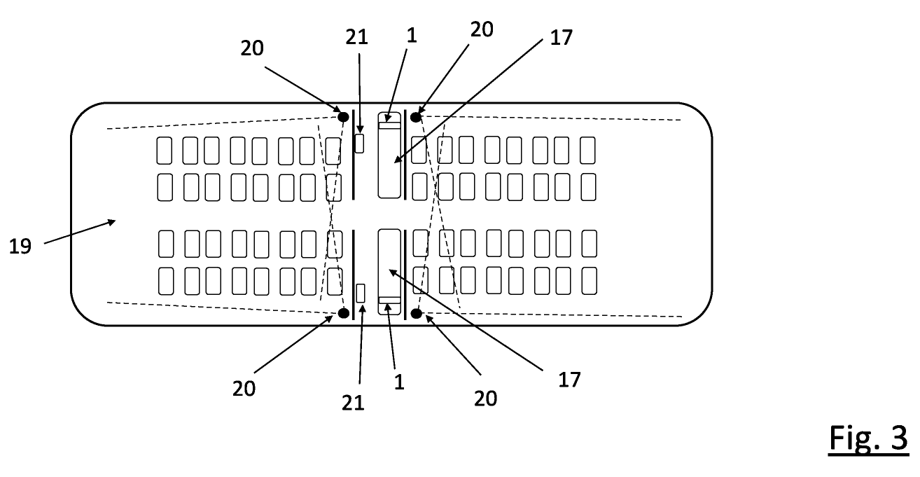

FIG. 3 shows a schematic plan view of an interior 19 of an aircraft. Illustrated in this aircraft interior 19 are in each case two aircraft interior equipment modules 17 with respective galley installation apparatuses 1.

The respective galley installation apparatuses 1 are in this case coupled to respective camera devices 20, wherein different manners of coupling are conceivable. It is also conceivable for respective galley installation apparatuses 1 to be designed to receive a variety of different camera contents and to display either all the contents or only one content by user settings. The abovementioned camera devices are located preferably in a so-called passenger service channel (PSC), which is arranged above the passenger seats.

The two aircraft interior equipment modules 17 are also designed to receive the respective galley installation apparatus 1 reversibly such that a respective display device 4 of the respective galley installation apparatuses 1 is oriented in the direction of a respective cabin crew seating area 21.

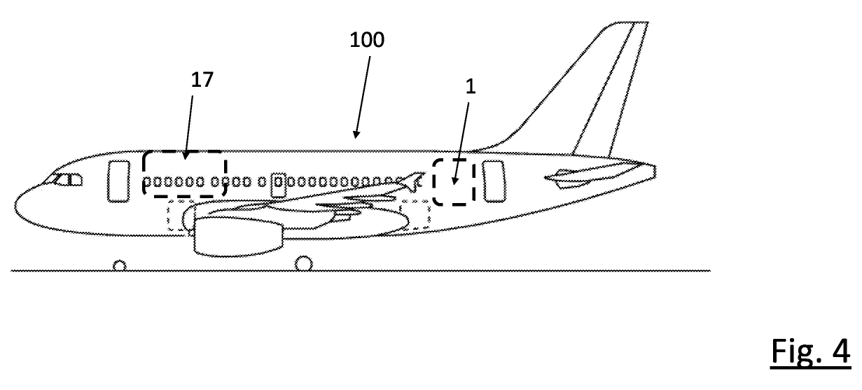

FIG. 4 shows a schematic view of an aircraft 100 according to the disclosure herein. This aircraft 100 is illustrated both with a galley installation apparatus 1 according to the disclosure herein and with an aircraft interior equipment module 17 according to the disclosure herein, in which, in turn, a galley installation apparatus 1 according to the disclosure herein, which is not illustrated in more detail, is able to be arranged.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiments. In addition, in this disclosure, the terms “comprise” or “comprising” do not exclude other elements or steps, the terms “a” or “one” do not exclude a plural number, and the term “or” means either or both. Furthermore, characteristics or steps, which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 Galley installation apparatus
2 Container
3 Receiving region
4 Display device
5 Electrical direct view system
6 Joint device
7 Rear panel element
8 Monitor unit
9 Rail bar
10 Surface region
11 Supply port
12 Camera port
13 Opening region
14 Fastening system
15 Fixing mechanism
16 Cross-sectional view
17 Aircraft interior equipment module
18 Placeholder
19 Aircraft interior
20 Camera device
21 Cabin crew seating area
100 Aircraft

1. A galley installation apparatus for aircraft, comprising a container with supply ports and at least one camera port, and an electrical direct view system in the container, wherein a display device of the electrical direct view system is mounted pivotably on the container by at least one joint device such that the display device is pivotable reversibly from at least one external position outside the container into an interior receiving region of the container, wherein the container comprises at least one fastening system for fastening to an aircraft interior equipment module such that a substantially fixed position of the electrical direct view system in the respective pivoted positions is able to be ensured during at least one use scenario.

2. The galley installation apparatus according to claim 1, wherein the display device comprises a rear panel element by which the display device is coupled to the at least one joint device, wherein the rear panel element has reinforcements in a direction of the at least one joint device such that a center of gravity of the display device with the rear panel element is shifted in the direction of the at least one joint device.

3. The galley installation apparatus according to claim 2, wherein the display device is horizontally movable in a continuously variable manner on the rear panel element, such that, depending on the use scenario that is set up, a center of gravity of the display device with the rear panel element is able to be shifted in the direction of the at least one joint device.

4. The galley installation apparatus according to claim 1, wherein the at least one joint device has reinforcements that at least partially overlap the rear panel element, such that a center of gravity of the display device with the rear panel element lies in a direction of the at least one joint device.

5. The galley installation apparatus according to claim 1, wherein the supply ports and the at least one camera port in the container are on a rear side on an opposite side from an opening region of the interior receiving region, such that the galley installation apparatus is able to be coupled automatically to supply media and cameras during a positioning process in an aircraft interior equipment module.

6. The galley installation apparatus according to claim 1, wherein at least one joint device comprises at least one fixing mechanism such that the display device is able to be reversibly fixed in a substantially fixed position in the external position.

7. The galley installation apparatus according to claim 1, wherein the at least one fastening system comprises at least one rail system with at least one lock, by which the galley installation apparatus is movable on the aircraft interior equipment module so as to be reversibly extendable and retractable with the lock released and is provided in a substantially fixed position with the lock fixed.

8. An aircraft interior equipment module for aircraft, comprising at least one galley installation apparatus according to claim 1.

9. The aircraft interior equipment module according to claim 8, wherein the aircraft interior equipment module is configured to receive the galley installation apparatus reversibly such that a display device is able to be oriented in a direction of at least one cabin crew seating area.

10. An aircraft comprising at least one galley installation apparatus according to claim 1.

11. An aircraft comprising the aircraft interior equipment module according to claim 9.
